(19) United States
(12) Patent Application Publication
(10) Pub. No.: US 2016/0110471 A1
(43) Pub. Date: Apr. 21, 2016

(54) METHOD AND SYSTEM OF INTELLIGENT GENERATION OF STRUCTURED DATA AND OBJECT DISCOVERY FROM THE WEB USING TEXT, IMAGES, VIDEO AND OTHER DATA

(71) Applicants: Ebrahim Bagheri, Toronto, Ontario (CA); John CUZZOLA, Kamloops (CA); Zoran JEREMIC, Burnaby (CA); Mohammadreza BASHASH, Santa Clara, CA (US)

(72) Inventors: Ebrahim Bagheri, Toronto (CA); John Cuzzola, Kamloops (CA); Zoran Jeremic, Burnaby (CA); Mohammadreza Bashash, Santa Clara, CA (US)

(21) Appl. No.: 14/892,976

(22) PCT Filed: May 21, 2014
(86) PCT No.: PCT/CA2014/000451

§ 371 Date: Nov. 20, 2015

Related U.S. Application Data
(60) Provisional application No. 61/825,995, filed on May 21, 2013.

(51) Int. Cl. G06F 17/30

(52) U.S. Cl. CPC G06F 17/30896; G06F 17/30864

(57) ABSTRACT

A computer implemented method and system enables use of a database of machine readable properties, features and traceable locations of real objects to search and locate and/or identify objects on the web by human input to a machine of image and/or oral cues relating to the object.

### FIELD OF INVENTION

This invention relates to the field of mapping and searching real world “objects” and their respective, representative locations within the web, on one or more web pages.

### BACKGROUND OF THE INVENTION

The Web is a system of interlinked documents that are accessed using a medium such as the Internet Search engines are generally capable of mapping a term to the location of a web document by searching in documents. However, hidden underneath each web document, lays real world objects (i.e. products, locations, etc.) that are only discovered when a human reads the document.

The history of the Inernet goes back beyond websites and mobile applications that are used today. Initially it was designed for human assisted computers to interact with one another and be able to compute data over a network of computers. Many technologies on top of the Internet, such as World Wide Web (web) and Electronic Mail (e-mail) were born to allow humans to share information and communicate.

Initially the web was designed to provide information in form of documents on the Internet. Since its existence it has evolved in a way that not only information is shared, but also services art offered. Interaction between web documents and humans became a norm for every website either providing information or catering a service. It eventually became one of the most important applications of the Internet that plays big role on everyone's life.

As computing devices continue to become less expensive, more and more powerful, and as capacity of data storage devices continues to rapidly increase, more and more data is being generated and stored, oftentimes as structured or semi-structured datasets. A dataset s a collection of data that conforms to either a formal schema (in the case of conventional relational databases), or to an informal conceptual model of the contents (in the case of NoSQL databases, including loose-schemata, semi-formal-schemata, and schema-free conceptual models), wherein the formal schema and/or conceptual model is conventionally defined by the producer or maintainer of the dataset. As used herein, the term “schema” is intended to encompass both a formal schema as well as an informal conceptual model of contents of a dataset. As will be understood by one skilled in the art of dataset generation/maintenance, a schema defines the structure and content of the dataset.

So, today more than ever, information plays an increasingly important role in the lives of individuals and companies. The Internet has transformed how goods and services are bought and sold between consumers, between businesses and consumers, and between businesses. In a macro sense, highly-competitive business environments cannot afford to squander any resources. Better examination of the data stored on systems, and the value of the information can be crucial to better align company strategies with greater business goals. In a micro sense, decisions by machine processes can impact the way a system reacts and/or a human interacts to handling data.

A basic premise is that information affects performance at least insofar as its searchability and hence accessibility is concerned. Accordingly, information has value because an entity (w nether human or non-human) can 1) find it and 2) typically take different actions depending on what is learned, thereby obtaining higher benefits or incurring lower costs as a result of knowing the information. In one example, accurate, timely, and relevant information saves transportation agencies both time and money through increased efficiency, improved productivity, and rapid deployment of innovations. For example, in the realm of large government agencies, access to research results allows one agency to benefit from the experiences of other agencies and to avoid costly duplication of effort.

The vast amounts of information being stored on networks such as the Internet and computers are becoming more accessible to many different entities, including both machines and humans. However, because there is so much information available for searching, the search results are just as daunting to review for the desired information as the volumes of information from which the results were obtained.

The web was designed to cater humans needs in a way that each human wanting information from a specific part of the web would have to personally navigate through the web either using search or other methods, find it and use it in a way that the makers the document decided. Web designing, navigation, search engine optimization became important for website owners only because they were directly talking to humans with minimal personalization.

Today's technology advancements such as smart phones, faster Internet and processing speeds led to existence of personalized agents. These computer entities act on behalf of users and instead of humans go after information on the web, they discover, normalize and personalize these information for their human owners so that it would benefit them. However, these personalized computer agents simply cannot read a web page as a human does. Each web page has a source code that only is readable by humans once rendered by a web browser. Often these codes are very unstructured that it would not make sense for anyone to look at this code and to understand.

The texts in these documents are in a language that humans understand, not computer bots or agents. Also images and video are designed specifically for humans.

There is a currant and as yet unresolved disconnect between these personalized computer agents (machines) which cannot read, translate and extract from web pages as a human can and the need for advanced searching by such agents on behalf of a human instructing said agent.

It is an object of the present invention to obviate or mitigate the above disadvantages.

### SUMMARY OF THE INVENTION

It is an object of the present invention to create an object to object search platform.

It is a further object of the invention to enable a machine (for example an agent) to read, translate and extract from web pages as a human can and to search on behalf of a human instructing said machine.

It is a further object of the present invention to collect a database of machine readable properties, features and traceable locations of real objects and to use such a database in a search platform to search, locate and/or identify such objects on the web by human input to a machine of image and/or oral cues relating to the object.

It is a further aspect of the present invention to enable a human user to input descriptors, features, and/or images relating to an object to a machine enabled search platform and to enable searching via the search platform to locate such object on the web.

The present invention provides, in one aspect, a computer implemented method of making a machine to machine structured data search platform, such platform enabling searching by a user employing image and/or oral cues, which method comprises one or more of the following steps, alone or in combination:
a) from a web block comprising an object in at least one of textual, image and html formats; i) identify and analyze text associated with the object, extract property and value points and annotations from the text (extracted text property and value points and annotations) ii), compare via horizontal searching the extracted text property and value points and annotations to a database, within the platform, of known text property and value points and annotations; iii) identify patterns in layout of the text in the web block (text layout property values); iv) compare text layout properly values with a database, within the platform of known text property values; v) match values; vi) identify embedded meta-data associated with the object in the web block;
b) from the web block, identify and analyze images associated with the object, i) extract at least one of a feature point and feature vector (extracted image features); ii) compare extracted image features to a database of features, within the platform; iii) match features; and
c) from the web block, identify recurring patterns in HTML structure related to object (structured schema properties) by i) retrieve embedded ontology concepts; ii) convert the ontology concepts to an N-triple format of subject-predicate-object annotation; iii) identify and extract property and value points within HTML recurring patterns (extracted HTML property and value point annotations); iv) compare HTML property and value points with a database, within the platform of known HTML property and value points v) match values.

The present application provides, in another aspect, a computer implemented method of correlating an object to one or more locations of the object on the World Wide Web by way of a machine to machine structured search platform, said method comprising one or more of the following steps, in any order:
a) from a web block comprising an object in at least one of textual, image and html formats: i) identify and analyze text associated with the object, extract property and value points and annotations from the text (extracted text property and value points and annotations) ii), compare via horizontal searching the extracted text property and value points and annotations to a database, within the platform, of known text property and value points and annotations; iii) identify patterns in layout of the text in the web block (text layout property values); iv) compare text layout property values with a database, within the platform of known text property values; v) match values; vi) identify embedded meta-data associated with the object in the web block;
b) from the web block, identify and analyze images associated with the object, i) extract at least one of a feature point and feature vector (extracted image features); ii) compare extracted image features to a database of features, within the platform; iii) match features; and

c) from the web block, identify recurring patterns in HTML structure related to object (structured schema properties) by i) retrieve embedded ontology concepts; ii) convert the ontology concepts to an N-triple format of subject-predicate-object annotation; iii) identify and extract property and value points within HTML recurring patterns (extracted HTML property and value point annotations); iv) compare HTML property and value points with a database, within the platform of known HTML property and value points v) match values.

The present invention comprises, in yet another aspect, a method of machine to machine identification of an object on the World Wide Web which method comprises
a) from a web block comprising an object in at least one of textual, image and html formats: i) identify and analyze text associated with the object, extract property and value points and annotations from the text (extracted text property and value points and annotations) ii), compare via horizontal searching the extracted text property and value points and annotations to a database, within the platform, of known text property and value points and annotations; iii) identify patterns in layout of the text in the web block (text layout property values); iv) compare text layout property values with a database, within the platform of known text property values; v) match values; vi) identify embedded meta-data associated with the object in the web block;
b) from the web block, identify and analyze images associated with the object, i) extract at least one of a feature point and feature vector (extracted image features); ii) compare extracted image features to a database of features, within the platform; iii) match features; and
c) from the web block, identify recurring patterns in HTML structure related to object (structured schema properties) by i) retrieve embedded ontology concepts; ii) convert the ontology concepts to an N-triple format of subject-predicate-object annotation; iii) identify and extract property and value points within HTML recurring patterns (extracted HTML property and value point annotations); iv) compare HTML property and value points with a database, within the platform of known HTML property and value points v) match values.

The present indention further provides a system for making a machine to machine structured data search platform, such platform enabling searching by a user employing image and/or oral cues, which method comprises one or more of the following steps, alone or in combination, which system comprises:

a) an electronic interface for the user to make a search request;

b) a server for presenting to the user, via the electronic interface, prompted questions relating to the search and to receive answers to the prompted questions;

c) at least one a searchable base data store;

d) a searching means to search attributes of the desired venue in the data store; and

e) a processor to receive information as follows: from a web block comprising an object in at least one of textual image and html formats: i) to identify and analyze text associated with the object, extract property and value points and annotations from the text (extracted text property and value points and annotations) ii) to compare via horizontal searching the extracted text property and value points and annotations to a database, within the platform, of known text property and value points and annotations; iii) to identify patterns in layout of the text in the web block (text layout property values); iv) to compare text layout property values with a database, within the platform of known text property values; v) to match values; vi) to identify embedded meta-data associated with the object in the web block; and from the web block, vi) identify and analyze images associated with the object, vii) extract at least one of a feature point and feature vector (extracted image features); viii) compare extracted image features to a database of features, within the platform; iii) match features; and from the web block, ix) identify recurring patterns in HTML structure related to object (structured schema properties) by i) retrieving embedded ontology concepts; ii) converting the ontology concepts to an N-triple format of subject-predicate-object annotation; iii) identifying and extract property and value points within HTML recurring patterns (extracted HTML property and value point annotations); iv) comparing HTML property and value points with a database, within the platform of known HTML property and value points and v) match values.

The present invention further provides a computer readable medium including at least computer program code for enabling the formation of a machine to machine structured data search platform and database, such platform and database enabling searching by a user employing image and/or oral cues, which method of formation comprises one or more of the following steps, alone or in combination, scraping from a plurality of webpages one or more of TEXT, HTML and IMAGES, processing TEXT by a Natural Language Processing Semantic Annotation method to form text attributes and features, processing HTML by a Structured Schema & Pattern Recognization method to produce HTML attributes and features and processing IMAGES by an Image Feature Extraction method to produce IMAGES attributes and features, collating the text attributes and features, the HTML attributes and features and the IMAGES attributes and features to a nearest neighbor; determing the closest match for each of via agglomerative clustering to determine the closest match between the content in the scraped webpage and the objects in the database (herein referred to interchangeably as the “inextweb database”).

There are significant advantages of the method and system of the present invention, including the enablement of personalized computer agents to “read” and extract usable information from a web page as a human does. The method and system of the present invention provide a search platform which “bridges” the machine readable source code of a web page that only is readable by humans once rendered by a web browser and the actual content of a rendered web page which is not understandable by a machine. By this bridge, a human user can use the search platform and database contained therein by describing the shapes of objects, colours or other properties that define the object or can search via visualization tools such as pictures and video. The machine is enabled by the platform of the invention to search based on these features and parameters.

Additionally, the present invention provides a computer system that crawls the web and automatically generates structured data from web documents. This data represents a set of objects that exist in a web document was heretofore only understood when an actual web browser rendered and displayed the web page. The method and system of the invention enables the extraction of desired information from web blocks using, for example, Machine-Learning, Natural Language Processing, semantic web and image recognition techniques.

Features of are object are stored within the platform of the invention in a way similar to humans recognizing real world objects. As noted above, a user is able to search a knowledge database associated with the platform by describing the shapes of objects, colors or other properties that define an object. This system is capable of searching for objects not only by describing, but also using visualization tools such as taking a photo of an item or detection of items in a video.

The data in knowledge database represents mapping between real world objects and their locations within a web page. It is anticipated that many parties such as search engines, computer agents, web services/sites, mobile applications, e-commerce applications and more will access and make use of this data.

### BRIEF DESCRIPTION OF THE FIGURES

FIG. 1 is a graphical illustration of an image on a website (circle within rectangle);

FIG. 2 is a series of photographs of known cameras (objects) which are comparable to unknown camera JC 18732;

FIG. 3 is a flow chart showing a top level summary of the system and method of the present invention;

FIG. 4 is a flow chart of the Number Annotator (steps 6.2.x.x);

FIG. 5 is a flowchart of Flowchart of CDF calculation—if the value to evaluate is to the right of the MAD, then the method provides to symetrically shift it to the left side of the normal distribution; compute the area under the curve using CDF; probability that value belongs to the set of property/value pairs is 2×CDF;

FIG. 6 is a flowchart of image processing steps in accordance with one aspect of the present invention; and

FIG. 7 is a schematic on the general computer architecture in which the method of the present invention may operate.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific retails are &et forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The algorithm and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Any algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### I Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “device” and “mobile device” refer herein to any personal digital assistants, Smart phones, other cell phones, tablets and the like.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or machine or distributed across several devices or machines.

As used herein, the term “data model” is intended to encompass a dataset schema. Moreover, as used herein, the term “entry” is intended to encompass a database instance, as well as database rows, documents, nodes, and edges (in the case of NoSQL databases). Additionally, the term “schema” is intended to encompass both formal schemes and informal conceptual models of contents of a dataset, including but not limited to conceptual models that aid in describing content and structure in semi-schematized datasets, schema-free datasets, loosely schematized datasets, datasets with rapidly changing schemas, and/or the like.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk dive for reading from and writing to a hard disk, and an optical disk drive and a magnetic disk drive for reading from and writing to removable optical disks and magnetic disks, respectively. The optical disk can be a CD-ROM while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”). Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or mere database systems, such as one or more remote compilers or networks. A computer may be logically connected to one or more client computers and/or database systems under any known method of permitting computers to communicate, for example through a network, such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, inducing wireless links.

While in most instances a computer will operable automatically where an end user application interface is provided, a user cam enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

### II Preferred Aspects

There is a plurality of aspects to the method of the present invention. Each is described in detail below

### Methodology:

In a preferred form, a WebCrawler visits a webpage and scrapes the TEXT, HTML, and IMAGES. These three types are separated and examined separately by three independent but parallel pipelines as follows:
a). TEXT is processed by Natural Language Processing Semantic Annotation Algorithm
b) HTML is processed by Structured Scheme & Pattern Recognizer Algorithm

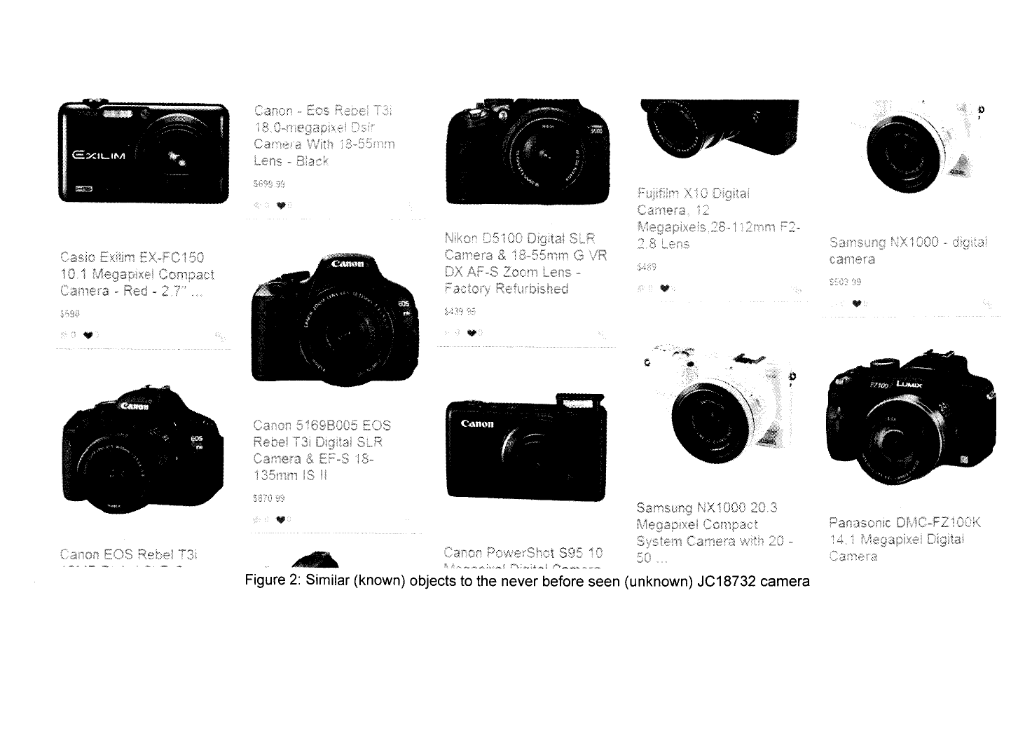

c) IMAGES are processed by Image Feature Extraction Algorithm
Each of these pipelines produce attributes or features identified within the scraped webpage. These features are collated and a nearest neighbor/agglomerative clustering analysis is done to determine the closest match between the content in the scraped webpage and the objects already discovered in the database of the invention (herein referred to interchangeably as the “inextweb database”). The properties of these database objects are then assumed to be potential properties to be found within the scraped webpage. A minimal (or common) spanning set of <subject, predicate, object> ontology triples that best covers the discovered properties is computed along with a probability (or confidence). For example, if the scraped webpage was describing a camera modes JC18732 (see FIG. 2) that was not seen before (not currently part of the inextweb database). Through the parallel processes (a, b, c) the method of the invention is used to identify that this webpage was describing similar objects to known (already in the database) camera models depicted in FIG. 2.

In this example, similar objects have already known properties such as: resolution, LCD size, shutter speed, aperture etc. . . . This set becomes the minimal spanning (or common) set of properties for the KNOWN objects. Therefore, the following information is inferred: that the scraped webpage containing the unknown object JC18732 is most likely a camera AND the webpage potentially contains relevant information about resolution, LCD size shutter speed, aperture, etc . . . pertaining to this newly discovered object JC18732. The scraped webpage is further scanned for the specific values associated with resolution, LCD size, etc . . . and a data structure of property/value pairs is constructed as follows:

{name→camera}

{model→JC18732}

{color→black}

{resolution→5→unit: “megapixel”}

{lcd size→3→unit “inches”}

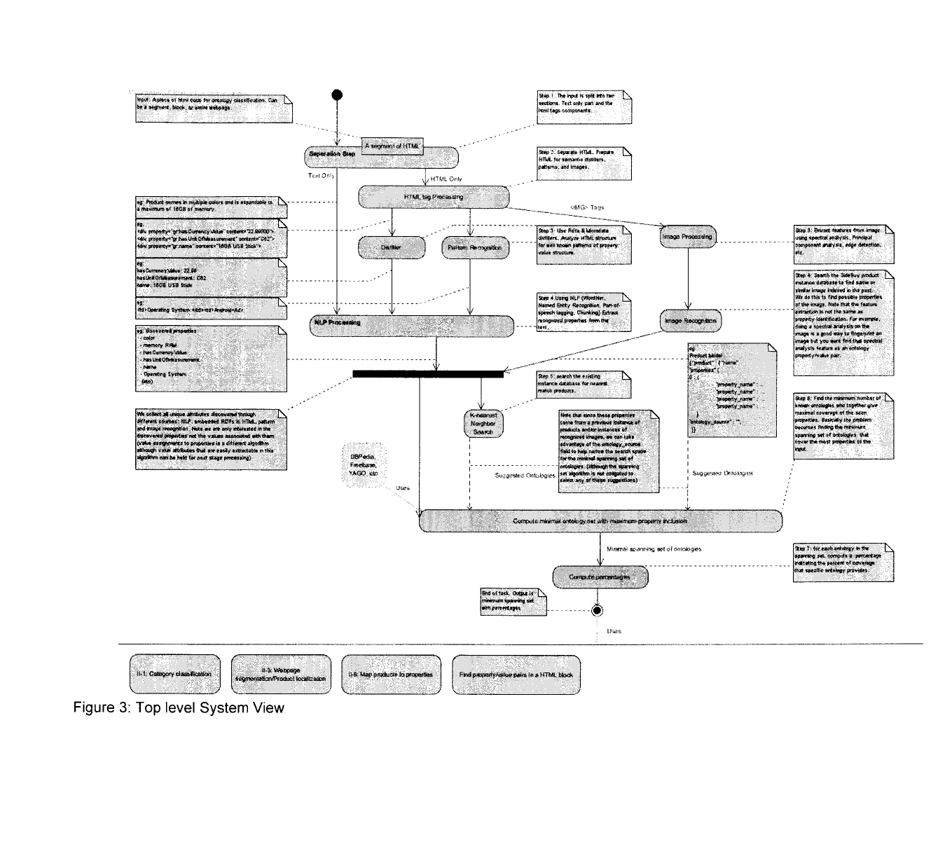

This newly discovered object is now stored in the inextweb database thus becoming part of the “known family of objects”. This entire top level process is outlined in FIG. 3.

### Text Analysis

The method of the invention enables information on webpages to be available for computer entities (machines) such as agents by making a structured format of the webpage that is understandable by machines.

To this end, the method reads text on a webpage, examines images and videos in a manner similar to humans.

### Input: Text, Image, Video

### Output: {Property:Value} Pairs

In one aspect, the method of the invention further uses Natural Language Processing (NLP) techniques to extract possible properties and their respective values out of text. For example: out of a text based description of a Smartphone product which describes the memory size of the product, and reads as such: “This Smartphone comes with two memory options, the first one is 16 GB and the second one is 32 GB”, the method of the invention extracts: {memory→{16, 32}→unit: “GB”}

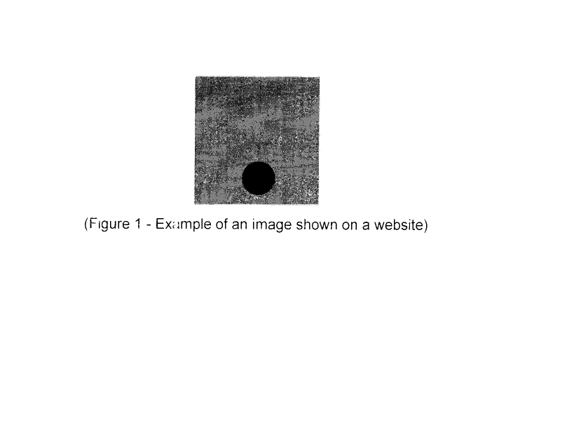

Such a method also breaks down images and or frames from videos regarded as images to distinctive objects known as descriptors. For example, given the image depicted in FIG. 1 the method of the invention extracts:

{rectangle→{(0, 0),(50, 300)}→color: “red”}

{circle→{(25, 20),12}→color: “black”}

NLP technologies can be employed to generate a semantic summary of the content and structure of the dataset. This semantic summary has a pre-defined structure that is uniform across semantic summaries of datasets, thereby readily allowing the semantic summaries to be efficiently searched over and organized. Additionally, NPL technologies can be employed over the metadata in connection with generating the semantic summary of the dataset. For example, NPL technologies can be employed to perform automatic summarization of unstructured text provided by the producer of the dataset. Additionally NPL technologies can perform natural language generation, which is the process of generating natural language from a machine representation system such as the schema in the dataset.

In addition to generating the semantic summary of the dataset, machine learning techniques and/or NLP techniques can be utilized to extract at least one entry from the dataset that is exemplary of the content of such dataset. In an example, a dataset may include automobiles that are indexed by make, model, color, year, etc. Accordingly, for instance, content of the dataset can be summarized based upon a product, a supplier, and a brand. This short semantic summary, however, may be insufficient to distinguish the content of the dataset from contents of other datasets, such as a dataset that includes tools that can be indexed by products, suppliers and brands. An exemplary entry in either of the datasets when provided to a user, however, can distinguish the contents of one of the datasets from the contents of the other dataset.

As feature points in the image or frames on a video. A combination of property and value pairs from text image and video describes the object in both text properties and visual properties. For example, a web page that describes a Smartphone and displays a picture of such a device, the method of the invention would extract:

{name→iphone}

{model→5}

{color→black}

{price→599→unit: “$”}

{rectangle→{(0, 0),(50, 300)}→color: “red”}

{circle→{(25, 20), 12}→color: “black”}

As much information as reasonably possible is extracted in order for a product to be fully descriptive.

In accordance with the method of the invention, once a machine readable source code has been “translated” into pairs of property/values, the object is categorized using similar objects previously found. For example, the following two objects share some characteristics therefore they belong to a sub class of similar properties.

Object1: {a→, b→y}

Object2: {a→z, b→y}

Object1 and object2 are similar in terms of property “b” in which they share the same values. In this way, the method of the invention categorizes objects on the fly or in situ based on their various intersections. For example, having multiple Smartphone data instances in the date base, the method of the invention may be used to classify all black Smartphones that have 16 GB of memory and are under $600.

The method and system operate by constantly or near constantly crawling desired web pages and caches and indexing a copy of unstructured data into a centralized document based database. In a preferred form, using a Semantic Tagging protocol, one of the desired indexed pages is accessed and its texts extracted. The text is then processed and a set of properties based on the context of the text is generated. Once the property tags are ready possible values for these properties are searched.

The method of the invention employs text annotation and property/value extraction of unstructured text using a horizontal search of similar concepts from a structured ontology. Text annotators such as DBPedia Spotlight, TagMe, and WikipediaMiner produce meta-tags that disambiguate text fragments that may have multiple interpretations. These words, known as homonyms share the same spelling and pronunciation but have very different meanings depending on the context of their use. For example: the word “orange” refers to either a fruit or a color. Disambiguation is the outcome of deciding which of these references is used in the context they appear in. A structured ontology (such as DBPedia) is used to link text to concepts.

For illustration, giver, an ontology represented as N-triples <subject,predicate,object>, and the following sentence:

“A BLT is made with bacon, lettuce, and tomato”

a text annotator would tag the text segment “bacon” as referring to the ontological concept of http://dbpedia.org/page./Bacon, “lettuce” to http://dbpedia.org/page/Lettuce. and “tomato” to http://dppedia.org/page/Tomato. This explicit annotation tends to tag text segments for what they are instead of how they are used (semantic role).

In the method of the present invention, text, segments are tagged to concepts but the methodology offers in the following way:

1. Text annotators link to the <subject> of the ontology, whereas the present method links to the <predicate, object>.

2. The present method focuses on matching many similar <subject>s to the text in order to find <predicate, object>s that will most likely be applicable to the text, thus allowing for annotation even when an exact concept match is not available.

Using this method, the results are annotations that tend to show the semantic role of the tagged text. For example, in the present method, “Bacon” would be tagged in the above example as an “ingredient to a BLT”. The output produced is in the form:

Index: from-to text

Primary [|Secondary] Concept: <context(role)\ [association] [value@idx] (confidence/support)

where:

from-to—The positional index (range) of the text that has been annotated.

text—The actual text that has been annotated.

Primary/Secondary—The primary (main) concept or usage of the annotated text in the context of the document being analyzed. Primary is selected by the best confidence/support score from the list of possible concepts for the tagged text. The remainders (if any) are secondary (alternative) concept(s) to the annotation.

context(role)—a URI identifying the role the tagged text is playing in the context of the document.

association—a URI describing a relationship between itself and the context(role). Meaning is dependent on the context (role) URI but generally can be read as “is a”, “is an”, “is used by”, and so forth. Association field is optional.

confidence—a probability (0-1) of the confidence of the concept.

value@idx—if the value at index idx is associated with the context(role)\[association]

support—a frequency count of the number of concepts(resources) that were found.

At the same time, in the method of the invention embedded meta-data is looked for that might be available on the source code to see if there is more information available by the author of the document. If it is found, such data is used in property/value extraction.

In accordance with a further aspect of the invention pattern recognition is used. Based on the historical data that is on a database, the method matches the pattern of the layout of bits of information such as tables, layers, images and etc to find what properties were previously taken from such a document and then uses the this information to find more property/values.

In parallel to each of the above-noted processes, and in accordance with a further aspect of the invention, the method identifies objects in one or more images, preferably using an Image Recognition module. The database is searched to find similar objects. If objects are found that share similar visual property/values, their text properties are then analyzed using the Semantic Annotation module to determine if such properties exist within the document. If so, searching for property/values continues until such point as there is confidence that there is enough affirmative information to classify the object. In other words, an object is either similar to a previously resolved object, and it would be classified as similar o that object, or if there are no similar objects with similar property/value pairs the object is recognized as a new object.

Within the platform of the invention, there is provided a database of objects that contain a plurality of property/value pair descriptors. Therefore this database can be queried by a user by emptying a description of an object and such object may be searched and located without knowing its name. Also, images that are unknown can be resolved into objects with known properties and values. These images may come from the web or uploaded by users u sing the camera on their Smartphones. It enables searching for an object using an image that is uploaded to the platform of the invention.

The platform of the invention may employ its historical data to optimize new searches (learning ability). Therefore, texts and images that are resolved would become known within the database of the platform and if something similar appears to be searched again, it can be simply matched.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

### III. Computing

Further and in addition to the disclosure provided above, it will be readily apparent to one of ordinary skill in the art that the various processes and methods described herein may be implex enter by, e.g., appropriately programmed general purpose computers, special purport computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” mean, one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used un place of, or in combination with, some or all of the software instructions that can implement the processes of various embodiments. Thus, various combinations of hardware and software may be used instead of software only.

The term “computer readable medium” refers to any medium, a plurality of the same, or a combination of different media that participate in providing data (e.g., instructions, data structures) which may be read by a computer a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any ether magnetic medium, a CD-ROM, DVD, any other optical medium, punch cards, paper tape, any other physical medium with patterns of holes, a RAM a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor, (ii) carried over a wireless transmission medium; (iii) formatted and/or transmitted according to numerous formats, standards or protocols, such as Ethernet (or IEEE 8(2.3), SAP, ATP, Bluetooth™, and TCP/IP TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

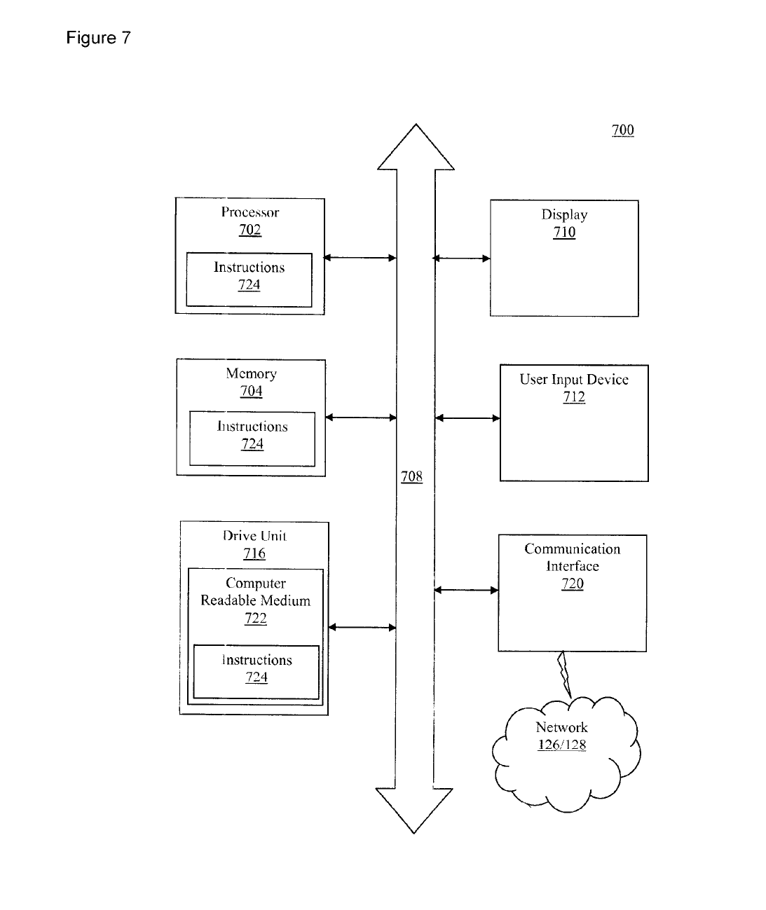

Turning to general architecture, as illustrated in FIG. 7, a computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but is rot limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 704 includes a cache or random access memory for the processor 702. In alternative embodiments, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the programmed processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 700 may further include a display unit 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 400 may include an input device 716 configured to allow a user to interact with any of the components of system 700 The input device 716 may be a number pad, a keyboard, or a cursor control device, such as a mouse, or a joystick, touch screen display, remote control or any other device operative to interact with the system 700.

In a particular embodiment, as depicted in FIG. 7, the computer system 700 may also include a disk or optical drive unit 706. The disk drive unit 406 may include a computer-readable medium 710 in which one or more sets of instructions 712, e.g. software, can be embedded. Further, the instructions 712 may embody one or more of the methods or logic as described herein. In a particular embodiment, the instructions 712 may reside completely, or at least partially, within the memory 704 and/or within the processor 702 during execution by the computer system 700. The memory 704 and the processor 702 also may include computer-readable media as discussed above.

The present disclosure contemplates a computer-readable medium that includes instructions 712 or receives and executes instructions 712 responsive to a propagated signal, so that a device connected to a network 720 can communicate voice, video, audio, images or any other data over the network 720. Further, the instructions 712 may be transmitted or received over the network 126/128 via a communication interface 918. The communication interface 718 may be a part of the processor 702 or may be a separate component. The communication interface 718 may be created in software or may be a physical connection in hardware. The communication interface 718 is configured to connect with a network 720, external media, the display 714, or any other components in system 700, or combinations thereof. The connection with the network 126/128 may be a physical connection, such as a wired Ethernet connection or may be established wirelessly as discussed below. Likewise, the additional connections with other components of the system 100 may be physical connections or may be established wirelessly.

The network 126/128 may include wired networks, wireless networks, or combinations thereof. The wireless network may be a cellular telephone network, an 802.11, 802.16, 802.20, or WiMax network. Further, the network 126/128 may be a public network, such as the Internet a private network, such as an intranet, or combinations thereof, and may utilize a variety of networking protocols now available or later developed including, but not limited to TCP/IP based networking protocols.

While the commute readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

Just as the description of various steps in a process does not indicate that all the described steps are required embodiments of an apparatus include a computer/computing device operable to perform some (but not necessarily all) of the described process.

Likewise, just is the description of various steps in a process does not indicate that all the described steps are required, embodiments of a computer-readable medium storing a program or data structure include a computer-readable medium storing a program that, when executed can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations of descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any description of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database

Various embodiments can be configured to work in a network environment including a computer that is in communication (e.g., via a communications network) with one or more devices The computer may communicate with the devices directly or indirectly, via any wired or wireless medium (e.g. the Internet, LAN, WAN or Ethernet, Token Ring, a telephone line, a cable line, a radio channel, an optical communications line, commercial or line service providers, bulletin board systems, a satellite communications link a combination of any of the above). Each of the devices may themselves comprise computers or other computing devices, such as those based on the Intel®, Pentium®, or Centrino™, processor, that is adapted to communicate with the computer. Any number and type of devices may be in communication with the computer.

In an embodiment, a server computer or centralized authority may not be necessary or desirable. For example, the present invention may, in an embodiment, be practiced on one or more device without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts n a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash medium any other computer readable data or program storage product. The software modules in the computer program product may also be distributed electronically, via the Internet or otherwise, by transmission of a data signal (in which the software modules are embedded) such as embodied in a carrier wave.

For instance, me foregoing detailed description has set forth various embodiments of the devices and/or processes via the use of examples. Insofar as such examples contain one of more functions and/or operations, it will be understood by those skilled in the art that each function and/or operation within such examples can be implemented, individually and/or collectively, by a wide range of hardware software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g. as me or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, these skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following recordable type media such as floppy disks, hard disk drives, CD ROMs, digital tape, flash drives and computer memory; and transmission type media such as digital and analog communication links using TDM or IP based communication links (e.g., packet links)

### EXAMPLE 1

### A-1. Pipeline(s): TEXT Processed by Natural Language Processing Semantic Annotation Algorithm

This pipeline is responsible to take the raw text of the scraped webpage, and by using a combination of natural language processing and statistical analysis, produce annotated text as described previously in the form of:
Index: from-to text
Primary [|Secondary] Concept: <context(role)\[association] [value@idx] (confidence/support)>

It does so by combining the efforts of two different modules:
Module 1: The Text Annotator. Responsible for producing this part of the concept: context(role)\[association]0 (confidence/support)
Module 2: The Number Annotator. Responsible for producing this part of the concept: value@idx (confidence/support)

Similar class of annotators such as TagME, and DSPedia Spotlight do not produce context(role) meta-information nor value@idx annotations.

### Algorithm Details:

1. Text (referred to now as the query) for annotation is supplied. Using tokenization and part-of-speech tagging, each token is grammatically identified which are used to perform the initial search for similar concepts from a structured ontology via a bag-of-words simple match.

2. The query is split into multiple ordered overlapping regions such that each partition contains a list of tokens whose sequential order is preserved but do not contain any similar tokens (i.e. the each partition contains an ordered list of unique tokens).

3. The inverse document frequency (IDF) of the words in step 1 is performed to find words with the highest IDF which act as a measure of information gain for searching on that word.

4. The ontology is searched with words from step 1 using the top-n IDFs from step 3which results in a list of ontological concepts that share similar words. These concepts are deemed to be similar and often belong to the same class (or inherited parent class) but not necessarily to. Hence, the horizontal the horizontal search across concepts.

5. A similarity coefficient using term frequency/inverse document frequency (TF/IDF) is computed on the description of the concepts from step 4 The list is sorted from high to low. Higher scores in dictate concepts that are textually more similar to the query than lower scores.

6. For each of sorted concepts (<subject>s) in step 5, the corresponding <predicate, object>s are retrieved.

6.0.1 Each of the <object>s are either text, a number, or a URI. If URI then the <object> is rewritten by following the URI reference and obtaining the label textual description of the reference and replacing the URI with this representation thus converting the <object> commoner from URI to text. A rule is established as follows: context (role)=<predicate>, association=URI, <object>=URI text reference. This defines the concept: context (role)\[association]

6.1 If the <object> is of type “text” then the text annotator procedure is invoked (steps 6.1.x.x below).

6.1.0 the <object>s of the n-triples are tokenized and part-of-speech tagged.

6.1.1 For each query partition (from step 2):

6.1.1.1 Matching tokens from 6.1 are identified and the ordinal position of the matched token is recorded. A minimum and maximum ordinal position (specifying a range of text) for each partition is found. This range becomes the annotated text that will link to the concepts.

6.1.1.2 A similarity coefficient is computed for the <object> of step 6.1. against the partition of step 6.1.1 using the range of text found in step 6.1.1.1. This calculation becomes the confidence: confidence=similarity coefficient. Combine this confidence with the rule generated from step 6.0.1 completes the concept→<context (role)\[association] (confidence/support)

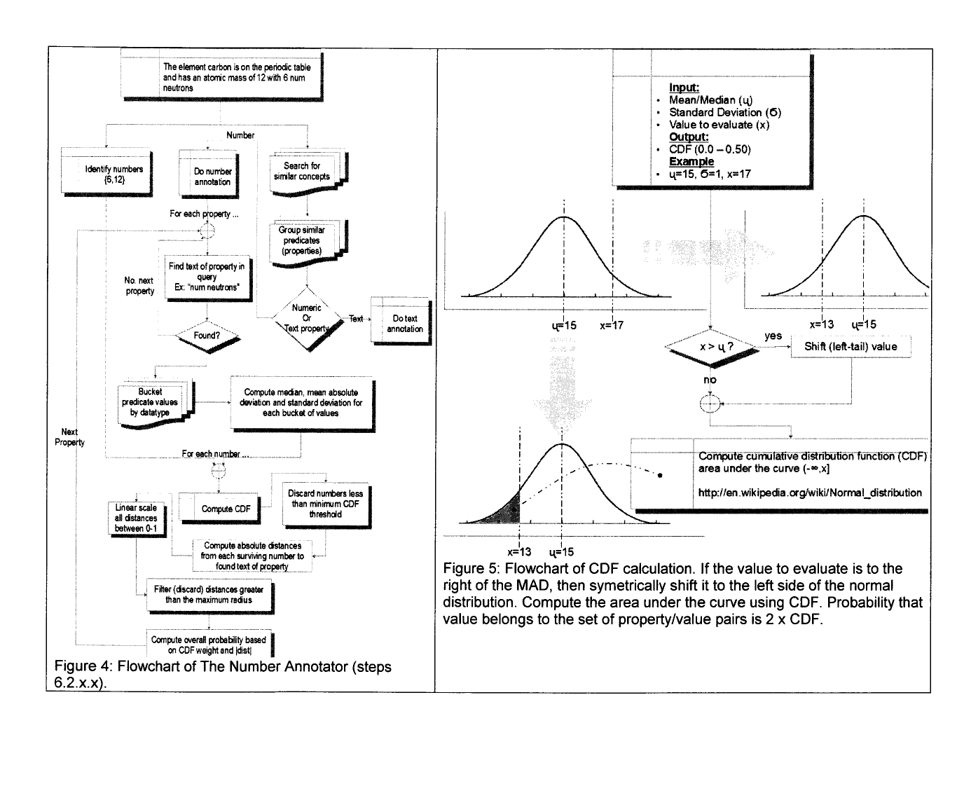

6.2 If the <object> is of type “number” then the number annotator procedure is invoked (steps 6.2.x.x below). FIG. 4 flowcharts the Member Annotator

6.2.0 For all numerical <object>s, separate them into groups by their datatype. Datatypes are explicitly defined by their schema. Concepts with matching predicates may have different datatypes.

An example is the memory datatype. This becomes the predicate of the concept. Ex:

<predicate>→<http://dbpedia.org/property/memory>

<object>→[35̂̂<http://www.w3.org/2001/XMLScheme#int>.

“512”̂̂<http://www.w/3.org/2001/XMLSchema#int>.

“80.0”̂̂<http://dbpedia.org/datatype/megabyte>] would group 35 and 512 together as similar datatype <http://www.w3.org/2001/XMLSchema#int> write 80 would be grouped separately as datatype <http://dbpedia.org/datatype/megabyte>.

6.2.1 or each separated group from step 6.2.0:

6.2.1.1 Calculate the median and median absolute deviation (MAD) and convert MAD to standard deviation. Median is used to remove extreme end values.

6.2.1.2 for each token of type number from the query:

6.2.1.2.1 Assume a normal distribution and compute the area under the curve with a cumulative distribution function (CDF) for each number of 6.2.12 using the median and standard deviation of 6.2.1.1. The area converts to a confidence/probability) that the number in the query belongs to the concept of step 6.0.1. The procedure for calculating this CDF is flowcharted in FIG. 5. The number itself becomes the annotated text.

7. Collect all confidence scores from 6.1.1.2 and 6.2.1.2.1. Group concepts together by annotated text (step 6.1.1.2 and 6.2.1.2.1).

7.1 For each annotated text group, sort concepts in order of confidence, frequency of occurrence (support and weighted coefficient (step 5). The top-ranked concept of each group becomes primary concept; the rest become secondary concepts.

### EXAMPLE 2

### A-2: Pipeline/b): HTML processed by Structured Schema & Pattern Recognizer Algorithm

This pipeline is responsible for parsing ontology information and identifying reoccurring patterns within the HTML structure of the scraped webpage. It is comprised of two modules.
Module 1: Schema Parser and Schema Resolver Responsible for retrieving explicit ontology concepts embedded in webpages in various formats such as RDFa using well known ontologies such as GoodRelations, Schema.org, OpenGraph (et al.) and converting it into X-triple format of <subject, predicate, object> sulfate for use by the A-1 semantic annotation pipeline. For example, the following webpage contains this embedded meta-information in OpenGraph format:

<meta property=“og:title” content=“Samsung ® 29 cu.ft Smooth French
Door Refrigerator ” />
<meta property=“og:type” content=“product” />
<meta property=“og:image”
content=“http://catalog.sears.ca/wcsstore/MasterCatalog/images/catalog/
Product_271/std_lang_all/62/_p/646_22162_P.jpg” />

The schema parser would translate this to N-triple format:

<uri:object_identifier> <uri:title> ”Samsung ® 29 cu.ft Smooth French
Door Refrigerator” @ en .
<uri:object_identifier> <uri:type> <uri:product> .
<uri:object_identifier> <uri:image>
<http://catalog.sears.ca/wcsstore/MasterCatalog/images/catalog/
Product_271/std_lang_all/62/_c/646_22162_P.jpg > .

The Schema Resolver is responsible for handling differences between schemas and to map similar resource concepts to an equivalent universal resource. For example: OpenGraph uses the og:title property while DBPedia calls the same property rdf:label. The resolver would reformat the property (either change og:title to rdf label or change rdf:label to og:title) to keep them consistent.
Module 2: Identified HTML Pattern Property/Value Extractor. This module attempts to discover property/values pairs from HTML patterns within the scraped webpage given that you can identify known (previously discovered) property/values. For example consider this fragment of a two-column HTML table:

<tr>
<td>Color</td> <td>Red</td>
</tr>
<tr>
<td>Camera resolution</td> <td>3.5 megapixels</td>
</tr>
<tr>
<td>Memory size</td> <td>4 GB</td>
</tr>
<tr>
<td>Warranty </td> <td> 3 years </td>
</tr>

The Pattern Recognizer may recognize the property/value combinations of Color:red and Warranty: 3 years from the existing inextweb database. Using this recognition as ‘anchor points’, this module would deduce the pattern: <tr><td<Property>/td><td>Property value</td></tr> and consequently extract the never before been properties of Camera→3.5 megapixels and Memory size→4 gb.

Module 1: Schema Parser and Schema Resolver Algorithm

Module 2: Identified HTML Pattern Property/Value Extractor Algorithm.

### EXAMPLE 3

### A-3: Pipeline (c): IMAGES Processed by Image Feature Extraction Algorithm

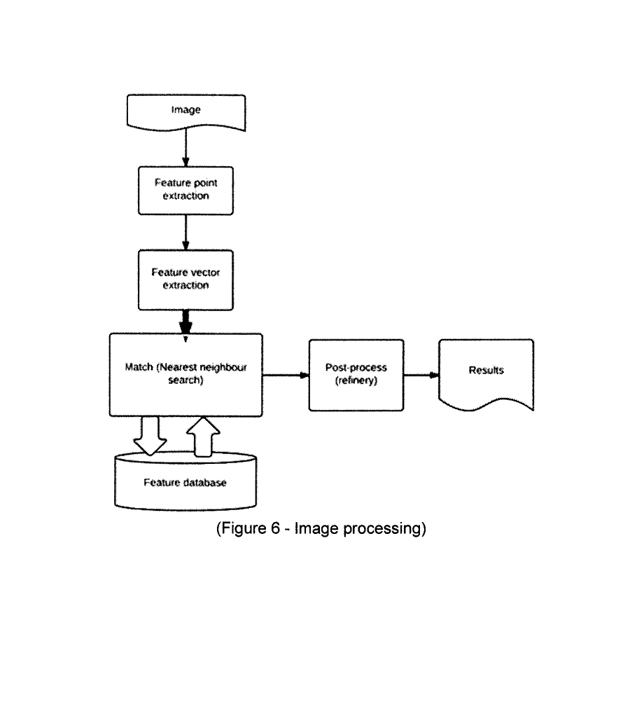

FIG. 6 provides a flow chart schematic wherein feature points and feature vectors are extracted and matched to a nearest neighbor based on a search of a feature database.

1. A computer implemented method of making a machine to machine structured data search platform, such platform enabling searching by a user employing image and/or oral cues, which method comprises one or more of a), b) and c) alone or in combination:
a) from a web block comprising an object in at least one of textual, image and HTML formats:
i) identify and analyze text associated with the object, and extract property and value points and annotations from the text thereby obtaining extracted text property and value points and annotations;
ii) compare via horizontal searching the extracted text property and value points and annotations to a database, within the platform, of known text property and value points and annotations;
iii) identify patterns in layout of the text in the web block thereby obtaining a plurality of text layout property values;
iv) compare the plurality of text layout property values with a database, within the platform of known text property values to match values; and
v) identify embedded meta-data associated with the object in the web block;
b) from the web block,
i) identify and analyze images associated with the object,
ii) extract at least one of a feature point and feature vector thereby obtaining extracted image features;
iii) compare extracted image features to a database of features, within the platform; and
iv) match features; and
c) from the web block, identify recurring patterns in HTML structure related to objects in the form of structured schema properties by
i) retrieving embedded ontology concepts;
ii) converting the ontology concepts to an N-triple format of subject-predicate-object annotation;
iii) identifying and extracting property and value points within HTML recurring patterns thereby obtaining extracted HTML property and value point annotations;
iv) comparing the HTML property and value points with a database, within the platform of known HTML property and value points; and
v) matching values.

2. The method of claim 1 wherein, at step a) further text property and value point annotations are acquired by:
i) identifying a subject in a segment of the text;
ii) matching the subject to a likely predicate and/or object of the text; and
iii) annotating the most likely match.

3. The method of claim 1 wherein the machine is one of a search engine, a computer agent, a web service engine or a mobile application engine.

4. A computer implemented method of correlating an object to one or more locations of the object on the world wide web by way of a machine to machine structured search platform, said method comprising one or more of a), b) and c) in any order:
a) from a web block comprising an object in at least one of textual, image and HTML formats:
i) identify and analyze text associated with the object, extract property and value points and annotations from the text thereby obtaining extracted text property and value points and annotations;
ii) compare via horizontal searching the extracted text property and value points and annotations to a database, within the platform, of known text property and value points and annotations;
iii) identify patterns in layout of the text in the web block thereby obtaining a plurality of text layout property values;
iv) compare the plurality of text layout property values with a database, within the platform of known text property values to match values; and
vi) identify embedded meta-data associated with the object in the web block;
b) from the web block,
i) identify and analyze images associated with the object,
ii) extract at least one of a feature point and feature vector thereby obtaining extracted image features;
iii) compare extracted image features to a database of features, within the platform; and
iv) match features; and
c) from the web block, identify recurring patterns in HTML structure related to objects in the form of structured schema properties by
i) retrieving embedded ontology concepts;
ii) converting the ontology concepts to an N-triple format of subject-predicate-object annotation;
iii) identifying and extracting and value points within HTML recurring patterns thereby obtaining extracted HTML property and value point annotations;
iv) comparing the HTML property and value points with a database, within the platform of known HTML property and value points; and
v) matching values.

5. A method of machine to machine identification of an object on the world wide web using any combination of a), b) and c) set out in claim 1.

6. A system for searching structured data on a search platform, such platform enabling searching by a user employing image and/or oral cues, which system comprises a first computer connected via a server to the world wide web that performs one or more of a), b) and c) alone or in combination:
a) from a web block comprising an object in at least one of textual, image and HTML formats:
i) identify and analyze text associated with the object, extract property and value points and annotations from the text thereby obtaining extracted text property and value points and annotations;
ii) compare via horizontal searching the extracted text property and value points and annotations to a database, within the platform, of known text property and value points and annotations;
iii) identify patterns in layout of the text in the web block thereby obtaining a plurality of text layout property values;
iv) compare the plurality of text layout property values with a database, within the platform of known text property values to match values; and
v) identify embedded meta-data associated with the object in the web block;
b) from the web block,
i) identify and analyze images associated with the object,
ii) extract at least one of a feature point and feature vector thereby obtaining extracted image features;
iii) compare the extracted image features to a database of features, within the platform;
iv) match features; and
c) from the web block, identify recurring patterns in HTML structure related to objects in the form of structured schema properties by
i) retrieving embedded ontology concepts;
ii) converting the ontology concepts to an N-triple format of subject-predicate-object annotation;
iii) identifying and extracting property and value points within HTML recurring patterns thereby obtaining extracted HTML property and value point annotations;
iv) comparing the HTML property and value points with a database, within the platform of known HTML property and value points; and
v) matching values.

7. A system for making a machine to machine structured data search platform, such platform enabling searching by a user employing image and/or oral cues which system comprises:
a) an electronic interface for the user to make a search request;
b) a server for presenting to the user, via the electronic interface, prompted questions relating to the search and to receive answers to the prompted questions;
c) at least one a searchable base data store;
d) a searching means to search attributes of a desired venue in the data store; and
e) a processor to receive information in accordance with a method comprising: from a web block comprising an object in at least one of textual, image and HTML formats:
i) identifying and analyzing text associated with the object, and extracting property and value points and annotations from the text thereby obtaining extracted text property and value points and annotations;
ii) comparing via horizontal searching the extracted text property and value points and annotations to a database, within the platform, of known text property and value points and annotations;
iii) identifying patterns in layout of the text in the web block thereby obtaining a plurality of text layout property values;
iv) comparing the plurality of text layout property values with a database, within the platform of known text property values to match values;
v) identifying embedded meta-data associated with the object in the web block; and from the web block,
vi) from the web block identifying and analyzing images associated with the object,
vii) extracting at least one of a feature point and feature vector thereby obtaining extracted image features;
viii) comparing extracted image features to a database of features, within the platform to match features;
ix) from the web block, identifying recurring patterns in HTML structure related to objects in the form of structured schema properties by a) retrieving embedded ontology concepts; b) converting the ontology concepts to an N-triple format of subject-predicate-object annotation; c) identifying and extracting property and value points within HTML recurring patterns thereby obtaining extracted HTML property and value point annotations; d) comparing the HTML property and value points with a database, within the platform of known HTML property and value points and e) matching values.

8. A computer readable medium including at least computer program code for enabling the formation of a machine to machine structured data search platform and database, such platform and database enabling searching by a user employing image and/or oral cues, which method of formation comprises one or more of the following steps, alone or in combination;,
scraping from a plurality of webpages one or more of text, HTML and images;
processing text by a Natural Language Processing Semantic Annotation method to form text attributes and features;
processing HTML by a structured schema and pattern recognition method to produce HTML attributes and features and processing images by an Image Feature Extraction method to produce images attributes and features;
collating the text attributes and features, the HTML attributes and features and the images attributes and features to a nearest neighbor; and
determining the closest match for each of via agglomerative clustering to determine the closest match between the content in the scraped webpage and the objects in the database.
